(19) United States
(12) Patent Application Publication
(10) Pub. No.: US 2010/0002324 A1
(43) Pub. Date: Jan. 7, 2010

(54) Optical Nanomaterial Compositions

(75) Inventors: Oleksiy Rozhin, Cambridge (GB); Andrea Ferrari, Cambridge (GB); William Ireland Milne, Suffolk (GB)

Correspondence Address: SWANSON & BRATSCHUN, L.L.C., 8210 SOUTHPARK TERRACE, LITTLETON, CO, 80120, US

(73) Assignee: CAMBRIDGE ENTERPRISE LIMITED, Cambridge (GB)

(21) Appl. No.: 12/439,152

(22) PCT Filed: Aug. 24, 2007
(86) PCT No.: PCT/GB2007/003239

§ 371 Date: Feb. 26, 2009

Related U.S. Application Data
(63) Continuation of application No. 11/513,484, filed on Aug. 31, 2006, now abandoned.

(51) Int. Cl. G02B 5/00; G02F 1/355

(52) U.S. Cl. 359/896; 252/582; 252/584; 977/834

(57) ABSTRACT

The present invention provides compositions (“Optical Nanomaterial Compositions”) comprising one or more nano-materials and an optical coupling gel or an optical adhesive. The invention also provides methods for using the Optical Nanomaterial Compositions as an index-matching gel, an optical adhesive or an optical film, all of which are suitable for optical and sensing de-vices applications, including but not limited to noise suppression, passive Q-switching, mode-locking, waveform shaping, optical switching, optical signal regeneration, phase conjugation, in filter devices, dispersion compensation, wavelength conversion, soliton stabilization, microcavity applications, in interferometers (such as the Gires-Tournois interferometer), optical, magneto-optical or electro-optical modulation, biochemical sensors and photodetectors.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

### 1. FIELD OF THE INVENTION

The present invention relates to Optical Nanomaterial Compositions comprising one or more nanomaterials and an optical coupling gel or an optical adhesive. The compositions are useful in optoelectronic, photonic and sensing applications.

### 2. BACKGROUND OF THE INVENTION

Optical coupling gels and optical adhesives are key components in modern light-wave systems. Optical coupling gels act as light junctions between optical fiber ends or surfaces of optical devices. They fill the gap between two mating parts and minimize reflections by matching the refractive indexes. Optical coupling gels are typically epoxy or silicone-based polymers, having excellent elastic and thermal properties as well as good chemical stability.

Optical adhesives are polymers which are used for the assembly of optical parts and optical elements used in optical fiber communication and other photonic systems. Optical adhesives can comprise organic or synthetic compounds, as well as acrylic, epoxy and silicone resins and can act as index-matching agents. The optical adhesives utilized can be cured either optically (e.g., UV) or thermally.

Organic and inorganic nanomaterials, such as single or multi-walled nanotubes, nanowires, nanodots, quantum dots, nanorods, nanocrystals, nanotetrapods, nanotripods, nanobipods, nanoparticles, nanosaws, nanosprings, nanoribbons, or branched nanomaterials, are of great interest to researchers in various fields such as chemistry, physics, materials science, and electrical engineering, due to their unique structures and unique electrical, mechanical, electro-optical and electromechanical properties. Accordingly, these nanomaterials show promise as components for electronic and optical and sensor devices.

Recently, the nonlinear optical properties of materials such as carbon nanotubes and PbSe and PbS quantum dots have attracted a great deal of interest. By “nonlinear optical properties” we refer to the nonlinear variations of the optical characteristics of a given material with changes in the intensity and power of incident and/or transmitted light. A typical example of nonlinear optical property is the saturable absorption of a material. In this case the material's optical absporption decreases nonlinearly with increased intensity and/or power of the incident light, up to a point where the material gets “bleached”, i.e. it becomes transparent to the incident light and allows almost unperturbed light transmission.

Some experimental studies have concentrated on the saturable absorption properties of carbon nanotube suspensions, nanotube-polymer compositions and PbSe nanoparticle solutions. These studies demonstrate that nanotubes, and nanomaterials in general, can exhibit very strong third-order optical nonlinearity. In addition, nanotubes and nanomaterials show ultrafast dynamics. These properties make nanotubes and nanomaterials attractive materials for use in numerous applications in the fields of optics, electronics and photonics.

Accordingly, nanomaterials show promise as a filler in optical coupling gels and optical adhesives, where the gel or adhesive incorporating nanotube and nanomaterial would have enhanced and versatile optical properties. This invention is directed to such optically useful compositions.

### 3. SUMMARY OF THE INVENTION

The present invention provides compositions (“Optical Nanomaterial Compositions”) comprising one or more nanomaterials and an optical coupling gel or an optical adhesive. The invention also provides methods for using the Optical Nanomaterial Compositions as an index-matching gel, an optical adhesive or an optical film, all of which are suitable for applications, including but not limited to noise suppression, passive Q-switching, mode-locking, waveform shaping, optical switching, optical signal regeneration, phase conjugation, in filter devices, dispersion compensation, wavelength conversion, soliton stabilization, microcavity applications, in interferometers (such as the Gires-Tournois interferometer), and optical, magneto-optical or electro-optical modulation. These are examples of what, from now on, will be referred to as “optical devices” or “nonlinear optical components”.

A further category of application include “sensor devices” such as bio-chemical sensors and photodetectors, which do not necessarily require the use of optical nonlinearitiues.

In one aspect, the invention provides a composition comprising:

(a) one or more nanomaterials; and

(b) an optical coupling gel.

In another aspect, the invention provides a composition comprising:

(a) one or more nanomaterials; and

(b) an optical adhesive.

These compositions are collectively referred to herein as the “Optical Nanomaterial Compositions.”

In another aspect, the invention provides optical and sensor devices comprising an Optical Nanomaterial Composition.

### 4. BRIEF DESCRIPTION OF THE DRAWINGS

FIG. 1 is a schematic diagram of a general procedure (denoted “General Procedure I” below herein) useful for making the Optical Nanomaterial Compositions of the present invention. One or more nanomaterials is taken up in an appropriate solvent and the mixture is sonicated to provide a dispersed nanomaterial solution. In a separate vessel, an optical coupling gel or optical adhesive is taken up in an appropriate solvent and sonicated to provide an optical coupling gel or optical adhesive solution. The optical coupling gel or optical adhesive solution and the dispersed nanomaterial solution are then mixed and sonicated to provide a nanomaterial suspension solution which is subjected to fast mixing followed by centrifugation to provide an Optical Nanomaterial Composition of the present invention.

FIG. 2 is a schematic diagram of a general procedure (denoted “General Procedure II” below herein) useful for making the Optical Nanomaterial Compositions of the present invention. One or more nanomaterials is taken up in a liquid optical coupling gel or optical adhesive and the solution is sonicated to provide a nanomaterial suspension in the optical coupling gel or optical adhesive. The suspension is then subjected to fast mixing followed by ultracentrifugation to provide an Optical Nanomaterial Composition of the present invention.

FIG. 3 is a schematic diagram illustrating how an Optical Nanomaterial Composition of the invention can be cured to provide a film, wherein said film can be formed directly on an optical circuit and used as an optical circuit component, or alternatively, the composite can be cured using UV light, heat or chemical-induced cross-linking to provide an Optical Nanomaterial Composition film.

FIG. 4 illustrates a Gires-Tournois interferometer, which is a transparent plate with two reflecting surfaces, one of which has very high reflectivity. Due to multiple-beam interference, light incident on the lower-reflectivity surface of a Gires-Tournois interferometer is almost completely reflected, but has a phase shift that depends strongly on the wavelength of the light. FIG. 4(a) shows a Gires-Tournois interferometer 10 having an Optical Nanomaterial Composition (dotted bar) sandwiched between two mirrors 14, 16, the first 14 of which is fully reflective (M1≧99.9%) and the second 16 of which is semi-transparent (M2≦80%). The interferometric structure is allowed to enhance the nonlinearity of the Optical Nanomaterial Composition. FIG. 4(b) shows a Gires-Tournois interferometer 20 wherein DC voltage has been applied to the Optical Nanomaterial Composition, resulting in electro-optical modulation of the light by the composition.

The present invention may be understood more fully by reference to the following detailed description, which is intended to exemplify non-limiting embodiments of the invention.

### 5. DETAILED DESCRIPTION OF THE INVENTION

In one aspect, the present invention provides Optical Nanomaterial Compositions comprising one or more nanomaterials and an optical coupling gel or an optical adhesive. In another aspect the invention provides methods for using the Optical Nanomaterial Compositions as stand-alone optical or sensor devices or as components of a photonic system. The invention also provides methods for using the Optical Nanomaterial Compositions as an index-matching gel, an optical adhesive or an optical film, all of which are suitable for applications, including but not limited to noise suppression, passive Q-switching, mode-locking, waveform shaping, optical switching, optical signal regeneration, phase conjugation, in filter devices, dispersion compensation, wavelength conversion, soliton stabilization, microcavity applications, in interferometers (such as the Gires-Tournois interferometer), and optical, magneto-optical or electro-optical modulation.

### 5.1 The Optical Nanomaterial Compositions

The Optical Nanomaterial Compositions of the invention comprise: (1) one or more nanomaterials; and (2) an optical coupling gel or an optical adhesive.

The Optical Nanomaterial Composition can be in the form of a liquid (e.g., a solution), a gel or a film. In one embodiment, an Optical Nanomaterial Composition that is in the form of a liquid or a gel is cured to provide a film. Such a film may be used as a free-standing film, or alternatively, the film may be affixed to a substrate, such as quartz, glass, or a dielectric mirror to construct an optical device, such as a lens, a prism, a polarization plate, a fiber end, a fiber surface, a waveguide facet, a waveguide surface, or a laser material surface. An Optical Nanomaterial Composition may also be used in a liquid or gel form and cured after the solution or gel is placed at the interface of two optical components. For example, an Optical Nanomaterial Composition that is in the form of a liquid or a gel may be placed in a suitable optical or sensing cell for similar applications.

When in liquid form, an Optical Nanomaterial Composition may further comprise a solvent, such as water, organic solvents, inorganic solvents, or mixtures thereof. Illustrative solvents include, but are not limited to, water, D₂O, acetone, ethanol, dioxane, ethyl acetate, methyl ethyl ketone, isopropanol, anisole, γ-butyrolactone, dimethylformamide, N-methylpyrroldinone, dimethylacetamide, hexamethylphosphoramide, toluene, dimethylsulfoxide, cyclopentanone, tetramethylene sulfoxide, xylene, ∈-caprolactone, tetrahydrofuran, tetrachloroethylene, chloroform, chlorobenzene, dichloromethane, 1,2-dichloroethane, 1,1,2,2-tetrachloroethane, and mixtures thereof. In certain embodiments, the Optical Nanomaterial Composition can be contained in a suitable optical or sensing cell.

In one embodiment, an Optical Nanomaterial Composition is in the form of a film.

In one embodiment, an Optical Nanomaterial Composition is in the form of a gel.

In another embodiment, an Optical Nanomaterial Composition is in the form of a solution.

In another embodiment, an Optical Nanomaterial Composition is affixed to a quartz substrate.

In still another embodiment, an Optical Nanomaterial Composition is affixed to a glass substrate.

In another embodiment, an Optical Nanomaterial Composition is affixed to a dielectric mirror.

In another embodiment, an Optical Nanomaterial Composition is affixed applied to a quartz, glass, or a mirror to construct an optical device, such as a lens, a prism, a polarization plate, a fiber end, a fiber surface, a waveguide facet, a waveguide surface, or a laser material surface.

In yet another embodiment, an Optical Nanomaterial Composition is used as an optical adhesive.

In another embodiment, an Optical Nanomaterial Composition is used as an index-matching gel.

In a further embodiment, an Optical Nanomaterial Composition is used as a light junction or optical interconnect.

In one embodiment, an Optical Nanomaterial Composition comprises a plurality of single-walled carbon nanotubes in an optical coupling gel or optical adhesive.

In one embodiment, a plurality of nanomaterials is randomly oriented in the optical coupling gel or optical adhesive of the Optical Nanomaterial Composition. In another embodiment, a plurality of nanomaterials is arranged in a regularly oriented array within the optical coupling gel or optical adhesive of the Optical Nanomaterial Composition.

The refractive index of the Optical Nanomaterial Composition can be fine-tuned by controlling the concentration of nanomaterial in the Optical Nanomaterial Composition.

### 5.2 The Nanomaterials

The term “nanomaterial” as used herein, refers to a structure having at least one dimension of less than about 500 nm. In various embodiments, a nanomaterial has at least one dimension of less than about 200 nm, less than about 100 nm, less than about 50 nm, less than about 20 nm or less than about 10 nm. In certain embodiments, each of the three dimensions of the nanomaterial has a dimension of less than about 500 nm, less than about 200 nm, less than about 100 nm, less than about 50 nm, less than about 20 nm or less than about 10 nm. In other embodiments, nanomaterials can have at least one dimension in the size ranging from about 0.5 nm to about 10 nm.

Illustrative nanomaterials useful in compositions of the invention include, but are not limited to, a single or multi-walled nanotube, a nanowire, a nanodot, a quantum dot, a nanorod, a nanocrystal, a nanotetrapod, a nanotripod, a nanobipod, a nanoparticle, a nanosaw, a nanospring, a nanoribbon, a branched tetrapod or any other branched nanomaterial, or any combination thereof. The nanomaterial can comprise organic materials, inorganic materials or a combination thereof.

In one embodiment, the nanomaterial is a single-walled carbon nanotube.

The nanomaterials may have a monocrystalline structure, a double-crystal structure, a polycrystalline structure, an amorphous structure, or a combination thereof.

The nanomaterials can comprise following elements or compounds: Au, Ag, Pt, Pd, Ni, Co, Ti, Mo, W, Mn, Ir, Cr, Fe, C, Si, Ge, B, Sn, SiGe, SiC, SiSn, GeC, BN, InP, InN, InAs, InSb, GaN, GaP, GaAs, GaSb, AlN, AlP, AlAs, AlSb, CdO, CdS, CdSe, CdTe, ZnO, ZnS, ZnSe, ZnTe, MgO, MgS, MgSe, MgTe, HgO, HgS, HgSe, HgTe, PbO, PbS, PbSe, PbTe, GeS, GeSe, GeTe, SnS, SnSe, SnTe, InO, SnO, GeO, WO, TiO, FeO, MnO, CoO, NiO, CrO, VO, CuSn, CuF, CuCl, CuBr, CuI, AgF, AgCl, AgBr, AgI, CaCN₂, BeSiN₂, ZnGeP₂, CdSnAs₂, ZnSnSb₂, CuGeP₃, CuSi₂P₃, Si₃N₄, Ge₃N₄, Al₂O₃, Al₂CO, InₓO_{y}, SnₓO_{y}, SiOₓ, GeOₓ, WₓO_{y}, TiₓO_{y}, FeₓO_{y}, MnₓO_{y}, CoₓO_{y}, NiₓO_{y}, CrₓO_{y}, VₓO_{y}, or MSiO₄, any alloys thereof, or any combination thereof, wherein x is an integer ranging from 1 to 5, y is an integer ranging from 1 to 5, and M is selected from Zn, Cr, Fe, Mn, Co, Ni, V, and Ti.

In one embodiment, the nanomaterial comprises Si.

The nanomaterials can also comprise metallic or non-metallic alloys other than those listed above, a polymer, a conductive polymer, a ceramic material, or any combination thereof.

In one embodiment, the nanomaterial comprises a semiconductive material.

When a nanomaterial comprises a semiconductive material, the semiconductive material may further comprise a dopant. Dopants useful in the present invention include, but are not limited to: a p-type dopant, such as Li, B, Al, In, Mg, Zn, Cd, Hg, C, Si, an element from Group I of the periodic table, an element from Group II of the periodic table, an element from Group III of the periodic table, or an element from Group IV of the periodic table; or an n-type dopant, such as, Si, Ge, Sn, S, Se, Te, P, As, Sb, Cl, an element from group IV of the periodic table, an element from group V of the periodic table, an element from group VI of the periodic table, or an element from group VII of the periodic table.

In one embodiment, the dopant is a p-type dopant.

In another embodiment, the dopant is an n-type dopant.

When the nanomaterial is a nanotube, nanowire or nanoribbon, the nanotube, nanowire or nanoribbon can comprise a conductive or semiconductive material, such as an organic polymer, pentacene or a transition metal oxide.

The term “nanowire” is defined as any elongated material as described herein that includes at least one cross-sectional dimension less than 500 nm and has an aspect ratio of greater than 10 and is understood to include “whiskers” or “nanowhiskers.” The term “nanorod” refers to an elongated material as described herein which has an aspect ratio less than that of a nanowire.

In one embodiment, the nanomaterial is a nanotube.

In another embodiment, the nanomaterial is an inorganic single or multi-walled nanotube.

In a specific embodiment, the nanomaterial is single-walled carbon nanotube.

In another embodiment, the nanomaterial is a nanowire.

In another embodiment, the nanomaterial is a nanodot.

In still another embodiment, the nanomaterial is a quantum dot.

In yet another embodiment, the nanomaterial is a nanorod.

In a further embodiment, the nanomaterial is a nanocrystal.

In still another embodiment, the nanomaterial is a nanotetrapod.

In another embodiment, the nanomaterial is a nanotripod.

In another embodiment, the nanomaterial is a nanobipod.

In yet another embodiment, the nanomaterial is a nanoparticle.

In yet another embodiment, the nanomaterial is a nanosaw.

In yet another embodiment, the nanomaterial is a nanospring.

In yet another embodiment, the nanomaterial is a nanoribbon.

In yet another embodiment, the nanomaterial is a branched nanomaterial.

In yet another embodiment, the Optical Nanomaterial Composition comprises more than one type of nanomaterial.

When the nanomaterial is a nanotube, nanowire or nanoribbon, the nanotube, nanowire or nanoribbon can comprise a conductive or semiconductive material, such as an organic polymer, pentacene or a transition metal oxide.

The nanomaterials may be obtained using any known methods, including, but not limited to, solution-based methods, vapor-phase methods or high-temperature substrate-based methods, such as those described in Greene et al., Angew. Chem. Int. Ed. 42:3031-3034 (2003) and International Publication No. WO 02/017362.

Methods for making nanocrystals are described, for example, in Puntes et al., Science 291:2115-2117 (2001), U.S. Pat. No. 6,306,736 to Alivastos et al., U.S. Pat. No. 6,225,198 to Alivastos et al., U.S. Pat. No. 5,505,928 to Alivastos et al., U.S. Pat. No. 6,048,616 to Gallagher et al., and U.S. Pat. No. 5,990,479 to Weiss et al., each of which is incorporated herein by reference in its entirety.

Methods for making nanowires are described, for example, in Gudiksen et al., J. Am. Chem. Soc. 122:8801-8802 (2000), Gudiksen et al., Appl. Phys. Lett. 78:2214-2216 (2001), Gudiksen et al., J. Phys. Chem. B105:4062-4064, Morales et al., Science 291:208-211 (1998), Duan et al., Adv. Mater. 12:298-302 (2000), Cui et al., J. Phys. Chem. B 105:5213-5216 (2000), Puentes et al., Science 291:2115-2117 (2001), Peng et al., Nature. 404:59-61 (2000), U.S. Pat. No. 6,306,736 to Alivastos et al., U.S. Pat. No. 6,225,198 to Alivastos et al., U.S. Pat. No. 6,036,774 to Lieber et al., U.S. Pat. No. 5,897,945 to Lieber et al. and U.S. Pat. No. 5,997,832 to Lieber et al., each of which is incorporated herein by reference in its entirety.

Methods for making nanoparticles are described, for example, in Liu et al., J. Am. Chem. Soc. 123:4344 (2001), U.S. Pat. No. 6,413,489 to Ying et al., U.S. Pat. No. 6,136,156 to El-Shall et al., U.S. Pat. No. 5,690,807 to Clark et al., each of which is incorporated herein by reference in its entirety.

In one embodiment, an Optical Nanomaterial Composition can comprise two or more distinct nanomaterials. For example, an Optical Nanomaterial Composition can comprise two different types of nanocrystal populations or a nanotube population and a nanoparticle population.

The total amount of nanomaterial present in an Optical Nanomaterial Composition is from about 0.0001% to about 99% by total weight of the Optical Nanomaterial Composition. In one embodiment, the nanomaterial is present in an amount of from about 0.01% to about 20% by total weight of the Optical Nanomaterial Composition. In various embodiments, the nanomaterial is present an amount of less than about 20%, less than about 15%, less than about 10%, less than about 5%, less than about 1%, less than about 0.5%, less than about 0.1%, and less than 0.01% by total weight of the Optical Nanomaterial Composition.

In one embodiment, the nanomaterial is randomly oriented in the optical coupling gel or optical adhesive of the Optical Nanomaterial Composition. In another embodiment, the nanomaterial is arranged in a regularly oriented array within the optical coupling gel or optical adhesive of the Optical Nanomaterial Composition.

To enhance or optimize the performance of the device or component in which the Optical Nanomaterial Compositions are deployed, the nanomaterial can be functionalized. Functionalization refers to the chemical or physical treatment of the nanomaterial surface aimed at modifying and optimizing characteristics such as nanomaterial dispersion and solubility in a host polymer matrix, as well as sensitivity in sensing and detection applications

### 5.2.1 Single-Walled Carbon Nanotubes

In one aspect, the invention provides Optical Nanomaterial Compositions comprising one or more single-walled carbon nanotubes and a synthetic silicone polymer. Single-walled carbon nanotubes are rolled up graphene sheets. Their twist or chirality defines their optical and electrical properties. In one embodiment, single-walled carbon nanotubes useful in the present invention have a diameter of from about 0.1 nm to about 10 nm. In another embodiment, the single-walled carbon nanotubes have a diameter of from about 0.5 nm to about 3 nm. In yet another embodiment, the single-walled carbon nanotubes have a diameter of from about 1.0 nm to about 1.5 nm.

In one embodiment, single-walled carbon nanotubes useful in the present invention have lengths of from about 0.01 μm to about 10 μm.

The diameter distribution and concentration of nanotubes in in an Optical Nanomaterial Composition can be manipulated to optimize the optical properties of such compositions.

The single-walled carbon nanotubes may be commercially available or, alternatively, can be made by any known means including, but not limited to, a chemical vapor deposition process, a laser ablation process, an arc process, a fluid bed process or a gas-phase process using carbon monoxide. Processes for making single-walled carbon nanotubes, include those disclosed, for example, in Liu et al., Science 280:1253-1256 (1998); M. Bronikowski et al., J. Vacuum Sci. Tech. A 19:1800-1805 (2001); U.S. Pat. No. 6,183,714; International Publication No. WO 00/26138; S. Dresselhaus et al., Carbon nanotubes, Topics of applied Physics 80, Springer (2001); S. Lebedkin et al., Carbon 40: 417-423 (2000); and International Publication No. WO 00/17102, each of which is incorporated herein by reference in its entirety.

Single-walled carbon nanotubes, whether purchased or synthesized, can further purified prior to incorporation into an Optical Nanomaterial Composition of the present invention using, for example, the methods set forth in International Publication No. WO 02/064,868, which discloses a halogenated gas-phase purification process; or International Publication No. WO 02/064,869, which discloses a process comprising first oxiding the nanotubes, then reacting the oxidized nanotubes with a halogenated acid, each of which is incorporated herein by reference in its entirety. The optoelectronic properties of carbon nanotube compositions can improve dramatically with increasing nanotube purity. It has been reported that high-purity carbon nanotube-containing polymer films can achieve up to 90% visible-light transmittance.

To enhance or optimize the performance of the device or component in which the Optical Nanomaterial Compositions are deployed, the carbon nanotube can be functionalized. Functionalization refers to the chemical or physical treatment of the nanotube surface to modify and optimize characteristics such as nanotube dispersion and solubility in a host polymer matrix, as well as sensitivity in sensing and detection applications.

The single-walled carbon nanotubes are present in an Optical Nanomaterial Composition in an amount of from about 0.0001% to about 99% by total weight of the Optical Nanomaterial Composition. In one embodiment, the single-walled carbon nanotubes are present in an amount of from about 0.01% to about 20% by total weight of the Optical Nanomaterial Composition. In various embodiments, the single-walled carbon nanotubes are in an amount of less than about 20%, less than about 15%, less than about 10%, less than about 5%, less than about 1%, less than about 0.5%, less than about 0.1%, and less than 0.01% by total weight of the Optical Nanomaterial Composition.

### 5.3 Optical Coupling Gels

In one embodiment, an Optical Nanomaterial Composition comprises one or more nanotube and nanomaterials and an optical coupling gel. Optical coupling gels are used as an optical coupling medium to facilitate light transmission through various optical components in an optical device or optical communication system. Such coupling gels are typically used at the interface of two optical components. Accordingly, in one embodiment, the Optical Nanomaterial Compositions of the present invention can be used as an index-matching material.

When used as an index-matching material, an Optical Nanomaterial Composition preferably has an index of refraction that is compatible with the indexes of refraction of the optical components the Optical Nanomaterial Composition and Nanostructure interacts with.

Optical coupling gels useful as dispersion media in the present invention include any optical coupling gel. In one embodiment, the optical coupling gel is commercially available. Illustrative examples of commercially available optical coupling gels include, but are not limited to, index matching liquid 150 (Norland Products, Cranbury, N.J.); Q2-3067, OE-4000, OE-4100 and OE-4200 (Dow Corning Corp., Midland, Mich.); and OG-1001 (Luxlink™, Hicksville, N.Y.); 0607 and 0608 (Cargille Laboratories, 55 Commerce Rd. Cedar Grove, N.J. 07009 USA

In one embodiment, when used as an index-matching material, an Optical Nanomaterial Composition has an index of refraction that is between the indexes of refraction of the optical components that the Optical Nanomaterial Composition interacts with.

The Optical Nanomaterial Compositions, when comprising an optical coupling gel, can be used as index-matching gels in fiber optics and telecommunications, and may be used in conjunction with pairs of mated connectors, with mechanical splices, or at the ends of fibers. In ene embodiment, the Optical Nanomaterial Compositions, when comprising an optical coupling gel, can also be used to reduce Fresnel reflection at the surface of an optical component and Fabry Perot filtering effects. In other embodiments, the Optical Nanomaterial Compositions, when comprising an optical coupling gel, can also be used for waveguide protection and cladding, splicing, connecting, gap filling, and component assembly.

### 5.4 Optical Adhesives

In one embodiment, an Optical Nanomaterial Composition comprises one or more nanomaterials and an optical coupling gel or optical adhesive which is an optical adhesive. Optical adhesives can be used for bonding optical components. Optical adhesives are thermally stable, show high optical transparancy in the 300-3000 nm spectral range, and have long operation lifetime. They can also act as index-matching agents to reduce the surface and insertion losses, as well as to control stress during the bonding of optical components.

The Optical Nanomaterial Compositions, when comprising an optical adhesive, can be used as optical adhesives themselves. When used as an optical adhesive, an Optical Nanomaterial Composition preferably has an index of refraction that is compatible with the indexes of refraction of the optical components that the Optical Nanomaterial Composition joins.

Optical adhesives useful as dispersion media in the present invention are polymers, including but not limited to, the commercially available optical adhesives NOA60, NOA61, NOA63, NOA65, NOA68, NOA71, NOA72 or NOA81 (Norland Products, Cranbury, N.J.); OP-64-LS, OP-65-LS, OP-66-LS, OP-52, OP-54, OP-4-20632, OP-4-20639, OP-4-20641, OP-4-20647, OP-4-20655, OP-4-20658, OP-4-20663, or OP-4-20725 (Dymax Corp, Torrington, Conn.); or 3-6371 UV Gel or 3-4112 UV Cure Gel (Dow Corning).

When the dispersion media is an optical adhesive, the Optical Nanomaterial Compositions can be used in a range of applications. These applications include, but are not limited to, optical devices such as noise suppression, passive Q-switching, mode-locking, waveform shaping, optical switching, optical signal regeneration, phase conjugation, in filter devices, dispersion compensation, wavelength conversion, soliton stabilization, microcavity applications, in interferometers (such as the Gires-Tournois interferometer), and optical, magneto-optical or electro-optical modulation. Moreover, the Optical Nanomaterial Compositions using an optical adhesive as a dispersion media can also be deployed in sensor devices such as bio-chemical sensors and photodetectors.

### 5.5 Making the Optical Nanomaterial Compositions

The Optical Nanomaterial Compositions of the invention can be made using the methods disclosed, for example, in International Publication No. WO 04/097853 to Grunlan et al., U.S. Pat. No. 6,782,154 to Zhao et al., International Publication No. WO 03/040026 to Connell et al., and Breuer et al., Polymer Composites, 25:630-645 (2004), each of which is hereby incorporated by reference in its entirety.

An Optical Nanomaterial Composition can be prepared in the form of a film using any known methodology for making nanotube/polymer composites such as that disclosed, for example, in U.S. Pat. No. 6,782,154 to Zhao et al. and International Publication No. WO 03/040026 to Connell et al., each of which is hereby incorporated by reference in its entirety.

Some general methods useful for making the Optical Nanomaterial Compositions of the present invention and films thereof are set forth below.

### General Method I for Making an Optical Nanomaterial Composition

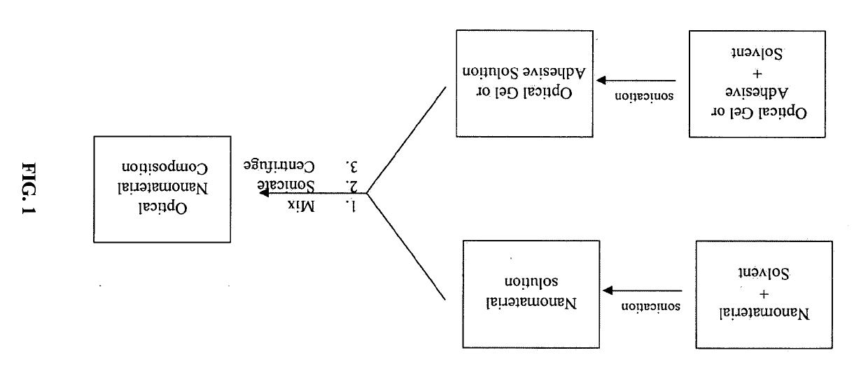

One or more of the nanomaterials is suspended in a solvent and the mixture is ultra-sonicated for a period of from about 30 seconds to about 48 hours. The sonication serves to evenly disperse the nanotubes and/or nanostructures within the solvent and to break up any nanotube and/or nanostructures aggregates, including long chains of nanomaterials. In a separate vessel, a dispersion media is dissolved in a solvent using sonication. The nanomaterials solution and the dispersion media solution are then mixed together and sonicated to provide a uniform suspension of the nanomaterials in the dispersion media solution. The suspension is then subjected to ultracentrifugation using centrifugal force of up to 1,000,000 g to provide an Optical Nanotube and Nanostructures Composition which may be used as is in solution or gel form or can be further concentrated in vacuo or by baking. This method is illustrated in FIG. 1.

Solvents useful in the methods for making the Optical Nanomaterial Compositions of the present invention include water, organic solvents, inorganic solvents, or mixtures thereof. Illustrative solvents include, but are not limited to, water, D₂O, acetone, ethanol, dioxane, ethyl acetate, methyl ethyl ketone, isopropanol, anisole, γ-butyrolactone, dimethylformamide, N-methylpyrroldinone, dimethylacetamide, hexamethylphosphoramide, toluene, dimethylsulfoxide, cyclopentanone, tetramethylene sulfoxide, xylene, ∈-caprolactone, tetrahydrofuran, tetrachloroethylene, chloroform, chlorobenzene, dichloromethane, 1,2-dichloroethane, 1,1,2,2-tetrachloroethane, and mixtures thereof.

When the solvent comprises water or organic solvents, the Optical Nanomaterial Composition can further comprise a surfactant to assist in stabilizing the nanotube suspension. Surfactants useful in the present methods include cationic, anionic, nonionic or amphoteric surfactants, water-soluble polymers, DNA, RNA and other bio-compounds. Illustrative examples of surfactants include those disclosed in International Publication No. WO 04/097853 to Grunlan et al., which is incorporated herein by reference in its entirety.

### General Method II for Making an Optical Nanomaterial Composition

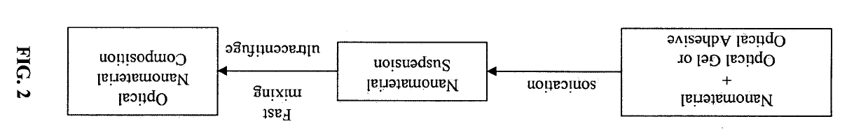

One or more of the nanomaterials is suspended in a optical adhesive or index matching gel, and the mixture is ultra-sonicated for a period of from about 30 seconds to about 48 hours. The sonication serves to initially disperse the nanotubes and/or nanostructures within the dispersing media and to break up any nanotube and/or nanostructures aggregates, including long chains of nanomaterials. The nanomaterials and the dispersion media are then mixed together by ultrafast homoginizer to provide a uniform suspension of the nanomaterials in the dispersion media solution. The suspension is then subjected to ultracentrifugation using centrifugal force of up to 1,000,000 g to provide an Optical Nanomaterial Composition which can be used as is in solution or gel form or can be further concentrated in vacuo or by baking. This method is illustrated in FIG. 2.

### One General Method for Making an Optical Nanomaterial Composition Film

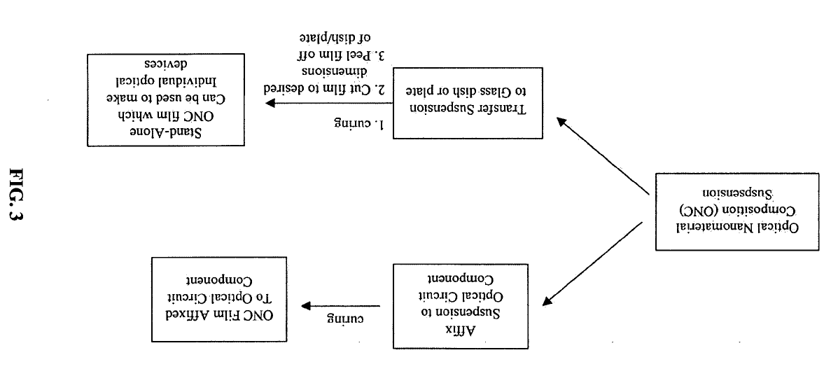

An Optical Nanomaterial Composition is applied onto a flat substrate or into a flat-bottomed vessel such as a glass or ceramic dish and all solvent is removed via baking at an appropriate temperature. The resultant residue is then subjected to UV radiation or further thermal annealing to cure the optical gel or optical adhesive. The cured composition can then be baked again to completely remove any residual solvent and provide a pure Optical Nanomaterial Composition film which can be peeled off of the substrate or vessel. This method is outlined in FIG. 3.

In one embodiment, the Optical Nanomaterial Composition is applied to a substrate using spin-coating.

The Optical Nanomaterial Composition can further comprise a surfactant to assist in stabilizing the nanotube suspension in the despersion media. Surfactants useful in the present methods include cationic, anionic, nonionic or amphoteric surfactants.

### 5.6 Uses of the Optical Nanomaterial Compositions

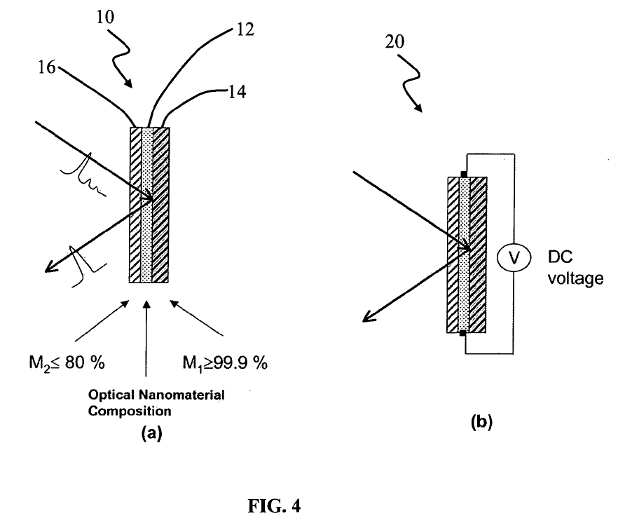

The Optical Nanomaterial Compositions of the invention are useful, for example, as an index-matching gel, an optical adhesive or an optical film and are suitable for applications in a range of optical and sensor devices for applications, including but not limited to noise suppression, for noise suppression, passive Q-switching, mode-locking, waveform shaping, optical switching, optical signal regeneration, phase conjugation, in filter devices, dispersion compensation, wavelength conversion, soliton stabilization, microcavity applications, in interferometers (such as the Gires-Tournois interferometer depicted in FIG. 4(a)), in optical, magneto-optical or electro-optical modulation (as depicted in FIG. 4(b)), as well as in biochemical sensors and photodetectors. Optical Nanomaterial Compositions are also useful as a light junction or optical interconnect.

In one embodiment, when used as an optical device, the Optical Nanomaterial Composition is affixed to a substrate, such as quartz, glass, or a mirror to construct an optical device; or a lens, prism, polarization plate, fiber end or fiber surface, waveguide facet or surface, laser material surface such as quartz, glass or a dielectric mirror. In one embodiment, the Optical Nanomaterial Composition is in the form of a film. The film can be pre-made and affixed to a substrate, or alternatively, the Optical Nanomaterial Composition can be applied to the substrate in solution or gel form and cured on the substrate using UV light or thermal curing, or cross linked or applied as it is to form a functional layer directly on the substrate.

### 5.6.1 Nonlinear Optical Components

The Optical Nanomaterial Composition films are useful as Nonlinear Optical Component. For such application, it is highly desirable to have a nonlinear optical material which possesses the following characteristics: (1) large nonlinear succeptibility; (2) low optical loss in the operating wavelength range; and (3) a high relaxation speed. It has been reported that composites comprising single-walled carbon nanotubes and polyimide have an ultrafast carrier dynamics with a recovery time of less than 1 ps at a wavelength of about 1.55 μm, and also have a high third-order polarizability caused by saturable absorption. Accordingly, such composites are of great interest in terms of their possible applications in high-speed optical communication devices, such as optical switches. See Chen et al., App. Phys. Lett. 81:975-977 (2002) and U.S. Pat. No. 6,782,154 to Zhao et al., each of which is hereby incorporated by reference herein in its entirety.

The Optical Nanomaterial Compositions are also useful as saturable absorbers. Saturable absorbers are can be used for ultrafast laser pulse generation and pulse reshaping to enhance the performance of high data rate fiber optic transmission.

Due to their saturable absorption properties, the Optical Nanomaterial Compositions are useful for noise suppression, for passive Q-switching, for mode-locking, waveform shaping, optical switching, optical signal regeneration, phase conjugation or filter devices, dispersion compensation, wavelength conversion, soliton stabilization, and microcavity applications (such as the Gires-Tournois interferometer).

In one embodiment Optical Nanomaterial Composition can be incorporated in actively controlled devices to achieve optical, magneto-optical or electro-optical modulation (see FIG. 4b).

In one embodiment, the Optical Nanomaterial Composition can be directly put into an optical fiber loop for switch applications.

In another embodiment, a switch comprising an Optical Nanomaterial Composition can be interconnected to other optical devices on a chip using a waveguide comprising an Optical Nanomaterial Composition.

In one embodiment, an Optical Nanomaterial Composition film is affixed to a substrate such as quartz, glass, or a mirror to construct an optical device, such as a lens, a prism, a polarization plate, a fiber end, a fiber surface, a waveguide facet, a waveguide surface, or a portion or surface of a laser material. The coated region can be employed as a saturable absorber. The saturable absorption properties can be fine-tuned by selecting specific nanomaterials and by varying the nanomaterial preparation and their concentration in the Optical Nanomaterial Compositions.

In one embodiment, the substrate is an integrated optical or photonic waveguide component.

Although the present invention has been described and illustrated in the foregoing exemplary embodiments, it is understood that the present disclosure has been made only by way of example, and that numerous changes in the details of implementation of the invention can be made without departing from the spirit and scope of the invention.

1. A composition comprising:
(a) one or more nanomaterials; and
(b) an optical coupling gel or an optical adhesive.

2. The composition of claim 1, wherein the composition comprises the optical coupling gel.

3. The composition of claim 1, wherein the composition comprises the optical adhesive.

4. The composition of claim 1, wherein the nanomaterial is randomly oriented in the optical material.

5. The composition of claim 1, wherein the nanomaterial is in a regularly oriented array in the optical material.

6. The composition of claim 1, wherein the one or more nanomaterials have at least one dimension in the size ranging from about 0.1 nm to about 500 nm.

7. The composition of claim 6, wherein the one or more nanomaterials have at least one dimension in the size ranging from about 0.5 nm to about 10 nm.

8. The composition of claim 6, wherein the nanomaterials have lengths of from about 0.01 μm to about 10 mm.

9. The composition of claim 1, wherein the one or more nanomaterials comprise nanomaterials purified from impurities.

10. The composition of claim 1, wherein the nanomaterials comprise chemically or physically functionalized nanomaterials.

11. The composition of claim 1, wherein the nanomaterial is selected from a group consisting of Au, Ag, Pt, Pd, Ni, Co, Ti, Mo, W, Mn, Ir, Cr, Fe, C, Si, Ge, B, Sn, SiGe, SiC, SiSn, GeC, BN, InP, InN, InAs, InSb, GaN, GaP, GaAs, GaSb, AlN, AlP, AlAs, AlSb, CdO, CdS, CdSe, CdTe, ZnO, ZnS, ZnSe, ZnTe, MgO, MgS, MgSe, MgTe, HgO, HgS, HgSe, HgTe, PbO, PbS, PbSe, PbTe, GeS, GeSe, GeTe, SnS, SnSe, SnTe, InO, SnO, GeO, WO, TiO, FeO, MnO, CoO, NiO, CrO, VO, CuSn, CuF, CuCl, CuBr, CuI, AgF, AgCl, AgBr, AgI, CaCN₂, BeSiN₂, ZnGeP₂, CdSnAs₂, ZnSnSb₂, CuGeP₃, CuSi₂P₃, Si₃N₄, Ge₃N₄, Al₂O₃, Al₂CO, InₓO_{y}, SnₓO_{y}, SiOₓ, GeOₓ, WₓO_{y}, TiₓO_{y}, FeₓO_{y}, MnₓO_{y}, CoₓO_{y}, NiₓO_{y}, CRₓO_{y}, VₓO_{y}, MSiO₄, any alloys thereof, and any combinations thereof, wherein x is an integer ranging from 1 to 5, y is an integer ranging from 1 to 5, and M is selected from Zn, Cr, Fe, Mn, Co, Ni, V, and Ti.

12. The composition of claim 1, wherein the one or more nanomaterials is selected from a group consisting of at least one nanotube, nanowire, nanodot, quantum dot, nanorod, nanocrystal, nanotetrapod, nanotripod, nanobipod, nanoparticle, nanosaw, nanospring, nanoribbon, and branched nanomaterial.

13. The composition of claim 1, wherein the nanomaterial comprises at least one nanotube.

14. The composition of claim 13, wherein the at least one nanotube comprises at least one single-walled carbon nanotube.

15. The composition of claim 1, further comprising an additional type of nanomaterial.

16. The composition of claim 1, wherein the concentration of nanomaterial in the composition is from about 0.0001% to about 50% by total weight of the composition.

17. The composition of claim 1, wherein the concentration of nanomaterial in the composition is from about 0.01% to about 20% by total weight of the composition.

18. A device comprising the composition of claim 1.

19. The device of claim 18, wherein the device is an optical device or a sensor device.

20. The device of claim 19, wherein the device is a nonlinear optical device.

21. The device of claim 18, wherein the composition is in the form of a film.

22. The device of claim 21, further comprising a quartz, a glass, or a mirror substrate.

23. The device of claim 18, wherein the device is a lens, a prism, a polarization plate, a fiber end, a fiber surface, a waveguide facet, a waveguide surface, or a laser material surface.

24. The device of any claim 18, wherein the composition is in the form of a liquid.

25. An index-matching gel comprising the composition of claim 1.

26. An optical adhesive comprising the composition of claim 1.
